(19) United States
(12) Patent Application Publication
(10) Pub. No.: US 2014/0171839 A1
(43) Pub. Date: Jun. 19, 2014

(54) CHEST CONTAINMENT SYSTEM

(71) Applicant: Hayden R. Fleming, Scottsdale, AZ (US)

(72) Inventor: Hayden R. Fleming, Scottsdale, AZ (US)

(21) Appl. No.: 13/713,751

(22) Filed: Dec. 13, 2012

(51) Int. Cl. A61H 31/00

(52) U.S. Cl. CPC A61H 31/00
USPC 601/41

(57) ABSTRACT

A chest containment system utilizes a thoracic cavity belt circumscribing a patient's chest for supporting a compression device in contact with the chest. Buckles are provided to tighten the belt. A supplemental strap is positioned over the top of the compression device and is releasably secured to each end thereof to the thoracic cavity belt at each side of the thoracic cavity.

### FIELD OF THE INVENTION

The present invention relates to the administration of cardiopulmonary resuscitation and more particularly to a chest containment system incorporating a thoracic cavity belt system to facilitate increased efficacy of resuscitation techniques.

### BACKGROUND OF THE INVENTION

The performance of manual cardiopulmonary resuscitation (CPR) by first responders of sudden cardiac arrest victims is disappointing despite years of extensive efforts and training by the American Heart Association and other organizations to improve the application of CPR and survival rates for the victims. The standards for manual CPR are the American Heart Association guidelines which call for at least 100 compressions per minute to a sternal depth of two inches into the chest when using manual compression technique. This standard is difficult to meet manually and generally cannot be sustained for more than a few minutes although the first responder may be physically fit.

Powered CPR systems have been developed that replace manual compressions required for proper performance and administration of CPR. See for example U.S. Pat. No. 7,060,041. Portability and simplicity of such systems for CPR are essential attributes of such systems but frequently they are cumbersome as a result of the requirement for the length of the stroke of the piston used in such devices to provide the compressive force on a patient's chest. Such powered devices, whether pneumatic or electrical, typically incorporate a housing having a piston that extends therefrom upon application of power to the unit. The housing is positioned on the patient's chest and is secured to the patient by a torso wrap or belt that surrounds the patient's chest and attaches to the housing. When the unit is powered, a piston extends axially from the housing into contact with the patient's chest and extends the required distance to provide the recommended 2 inch compression to the chest of the patient. Typically, when the piston extends into contact with the patient and presses on the patient's sternum, the forces applied by the piston to the patient's chest result in reaction forces directed opposite to the piston movement and urge the housing upward away from the patient's chest. The reaction forces resulting from the piston pressing on the patient's chest effectively decreases the depth or distance that the chest is compressed. Tightening of the torso wrap or strap surrounding the patient's chest cannot effectively limit the motion of the housing in response to this reaction force. Consequently, the housing, piston, and operating system of the powered resuscitation device must be scaled to accommodate the lost motion resulting from the movement of the housing away from the patient in response to the reaction force when the piston extends into contact and compresses the patient's chest. The result is a device that is larger and more cumbersome than needed to produce an effective compression of the chest.

### SUMMARY OF THE INVENTION

The present invention provides apparatus for improving the efficacy of a resuscitation effort. A circumscribing thoracic cavity belt is provided having a significantly increased width over the prior art to substantially increase the volume of the thoracic cavity that is being constrained in opposition to applied compression forces during the resuscitation effort. A powered resuscitation device, which may be pneumatic or electrical, such as that shown in the above identified U.S. Pat. No. 7,060,041 is appropriately positioned on the patient's chest and secured in contact with the patient by the thoracic cavity belt. To prevent the housing of the powered resuscitation device from rising out of contact with the patient's chest during the extension of the device's piston into contact with the patient, a supplemental strap contacts and is positioned at the top of the device's housing with the opposite ends of the supplemental strap secured to the thoracic cavity belt at the sides of the patient's chest. In this manner, the reaction forces resulting from the extension of the piston into contact with the patient's chest are directed from the top of the device's housing to the sides of the patient and the circumscribing thoracic cavity belt. Motion of the device's housing is thus restrained and the extension of the piston from the housing becomes substantially more effective in its compression of the patient's chest.

### BRIEF DESCRIPTION OF THE DRAWINGS

The present invention may more readily be described by reference to the accompanying drawings in which:

FIG. 1 is a perspective view of a powered CPR device and circumscribing thoracic cavity belt positioned on a patient without a supplemental strap or belt.

FIG. 2 is an enlarged view of the powered CPR device and circumscribing thoracic belt of FIG. 1.

FIGS. 3 and 4 are perspective and end views, respectively, of a thoracic cavity belt and powered CPR device utilizing a supplemental strap in accordance with the present invention for redirecting forces caused by the reaction to the operation of the powered CPR device.

FIGS. 5 and 6 are perspective views of alternate embodiments of the present invention.

### DETAILED DESCRIPTION OF THE INVENTION

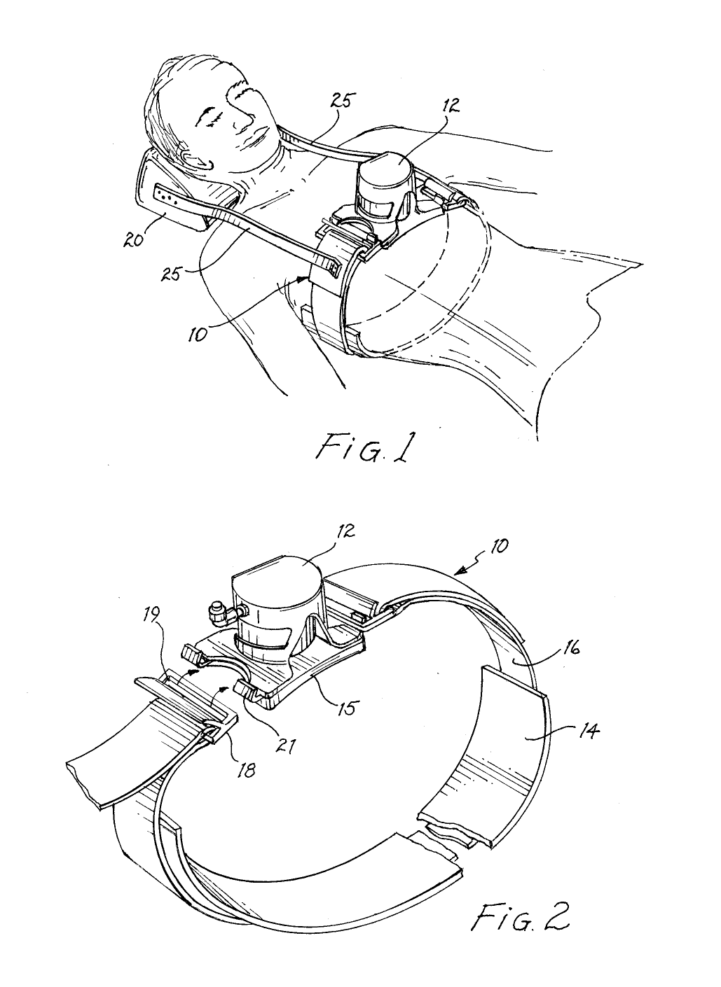

Referring to FIG. 1, a chest containment system is shown schematically represented on the chest of a patient. The containment system incorporates a pneumatically powered compression device 12. The device is maintained in its strategic position on the patient's chest through the utilization of stabilizer straps 25 extending from a cushion or headrest 26 to a thoracic cavity belt 10 and secured to the belt by well known hook and loop contact securement. The thoracic cavity belt 10 circumscribes the patient's thoracic cavity and may more readily be seen by reference to FIG. 2 wherein it may be seen that a primary strap 14 is provided that partially circumscribes the patient's thoracic cavity when the strap is in place on the patient. The primary strap 14 is a minimum 5 to 6 inches wide and preferably 7 inches wide or more and may be formed of a laminated neoprene and cotton to provide transverse stiffness to maintain a maximum area of belt-patient contact with the patient during compression and release of pressure cycles administered in the resuscitation process.

A secondary strap 16, narrower than the primary strap and attached thereto extends further around the patient's thoracic cavity. The secondary strap 16 is narrower than the primary strap but nevertheless is at least 4 inches wide to maintain a significant belt-patient contact area with the thoracic cavity of the patient. The secondary strap may be made of cotton to receive and become releasably attached to “hook” material to form a hook and loop fastening connection with the patches of hook material 30 strategically positioned on one side of the secondary strap. Each end of the secondary straps is threaded through a corresponding attachment buckle 18 and is folded back upon itself with the respective ends secured to the secondary strap through the aforementioned hook and loop contact. The attachment buckles 18, in addition to receiving the ends of the secondary strap, incorporate hook engaging slots 17 to receive buckle engaging hooks 21 attached to a strap insert 15. The thoracic cavity belt 10 is then tightened by pulling the ends of the secondary strap through the attachment buckles with sufficient force to firmly secure the powered CPR device in place. In the powered CPR device shown in FIGS. 1 and 2, the strap insert 15 may be a rigid platform for supporting a pneumatically powered compression device 12.

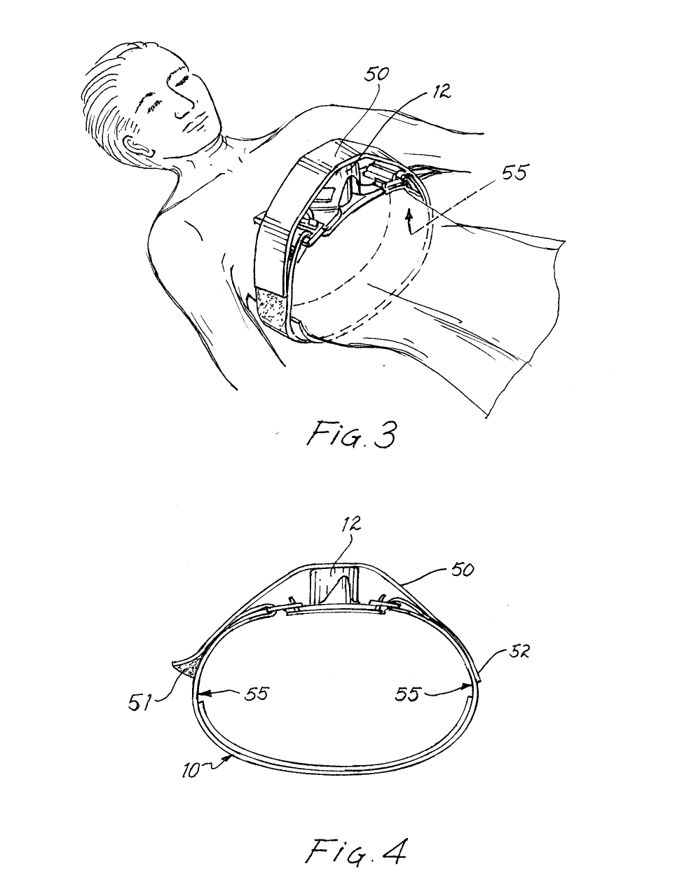

The powered compression device 12 is thus positioned and supported by the thoracic cavity belt 10; however, the forces exerted by the powered device when activated (causing a piston to extend from the device into engagement with the patient's chest) frequently results in the separation of the thoracic cavity belt from contact with the patient. That is, the force of the piston extending from the powered compression device creates a reaction force that tends to lift the device, and the thoracic cavity belt 10 away from intimate contact with the patient's chest. To counteract such forces a flexible supplemental strap 50 is provided that is secured through hook and loop contact at each end thereof to the thoracic cavity belt 10. The supplemental strap 50 contacts the top of the powered compression device 12 opposite the device's extendable piston. The implementation of a preferred embodiment of the present invention is shown in FIGS. 3 and 4 wherein it may be seen that the flexible supplemental strap 50 is attached, through a hook and loop engagement, at one end 51 to the belt 10, is positioned over the top of, and in contact with, the powered compression device 12, and is secured at the opposite end 52 to the belt 10 through another hook and loop contact. In this manner, the reaction forces tending to lift the powered compression device away from the patient's chest are countered by the supplemental strap directing such upward forces to the thoracic belt at the sides 55 of the thoracic cavity. The strap 50 may be fabricated from any flexible material of sufficient strength to withstand the strap tension resulting from the reaction forces imposed by the powered compression device; further, the strap 50 should essentially be non-elastic or non-stretchable to enable the unmodulated or diminished transmission of tensile forces. The stabilizer straps 25 of FIG. 1 may be attached prior to or after the positioning of the supplemental strap 50 and may be attached to either the supplemental strap 50 or the thoracic belt 10.

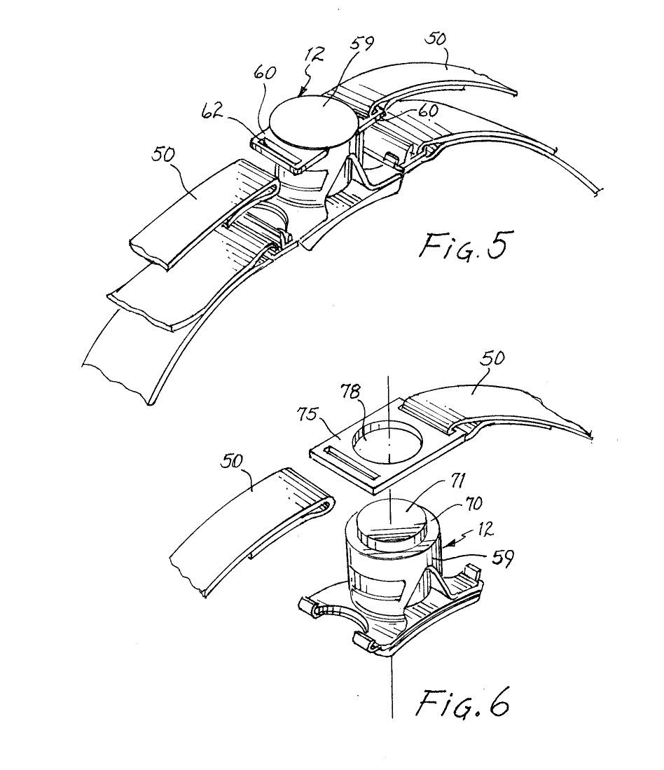

Referring to FIG. 5, an alternative embodiment of the system of the present invention is shown. The supplemental strap 50 is provided in two sections, each of which is secured to the compression device 12. In the embodiment shown in FIG. 5, the housing 59 of the compression device 12 is provided with extensions or handles 60 which may be formed integrally therewith or may be separate elements secured to the housing 59. The handles are each provided with a strap receiving slot 62 to receive the supplemental strap. The attachment to the housing 59 may be permanent (such as by stitching the supplemental strap after threading through the slot 62) or may be releasably secured such as by folding the supplemental strap back upon itself to be secured in a hook and loop contact connection. The remote ends of the supplemental strap 50 (not shown in FIG. 5) are releasably attached as previously described to the thoracic cavity belt 10 at the sides of the thoracic cavity.

Referring to FIG. 6, another embodiment of the system of the present invention is shown. The housing 59 of the compression device 12 is provided with a step or ledge 70 adjacent the top 71 thereof. The thoracic belt is not shown in FIG. 6 to facilitate the description of the embodiment shown; however, the thoracic belt would be connected to the compression device 12 in a manner similar to that shown in the previous figures.

The supplemental strap 50 is formed in two parts, each of which is connected to a bracket 75. The bracket may be formed of rigid plastic material and is provided with a strap receiving slots 77 to receive the supplemental strap. The supplemental strap may be permanently or releasably secured to the bracket 75. The bracket is provided with a circular opening 78 having a diameter slightly larger than the diameter of the top 71 to permit the bracket to engage and be supported by the ledge 70. The ends of the supplemental strap 50 (not shown in FIG. 6) extend to and are releasably secured to the thoracic belt at the sides of the thoracic cavity as described above in connection with the previous embodiments.

The method of the present invention comprises the steps of placing the powered compression device in contact with the patient's chest in a selected location (usually the patient's sternum) and placing the thoracic belt around the patient's chest and securing ends of the thoracic belt to the powered compression device. These two steps need not be in any particular order; that is, the thoracic belt may be wrapped about the patient's chest followed by the positioning of the compression device at a proper location on the chest and followed by attachment to the thoracic belt. After the compression device and thoracic belt have been appropriately positioned, the thoracic belt is then tightened to secure the belt in position and firmly hold the compression device in contact with the patient's chest. The supplemental strap is then placed in contact with the top of the compression device and the two opposite ends thereof are releasably attached to the thoracic belt at the sides of the thoracic cavity. Placement of the supplemental strap at the top of the compression device may be a simple strap/device contact as indicated in FIG. 3 or may take the form of the strap secured to the compression device as in the embodiment of FIG. 5 or the placement of a bracket formed as part of the supplemental strap in contact with the top of the compression device as described in connection with the embodiment of FIG. 6.

The present invention has been described in terms of selected specific embodiments of the apparatus and method incorporating details to facilitate the understanding of the principles of construction and operation of the invention. Such reference herein to a specific embodiment and details thereof is not intended to limit the scope of the claims appended hereto. It will be apparent to those skilled in the art that modifications may be made in the embodiments chosen for illustration without departing from the spirit and scope of the invention.

What is claimed:

1. A chest containment system for the administration of cardiopulmonary resuscitation comprising:
(a) a powered compression device positionable on a patient's chest and having an extendable piston extending therefrom into contact with the patient's chest when the device is activated, said powered compression device having a top opposite the extendable piston;
(b) a thoracic cavity belt attachable to said powered compression device and when in place on a patient circumscribing the patient's thoracic cavity to maintain a selected position of the powered compression device on the patient's chest; and
(c) a flexible supplemental strap in contact with the top of said powered compression device, said strap extending from said top into contact with, and secured to, said thoracic cavity belt at opposite sides of the thoracic cavity, respectively;
whereby reaction forces resulting from the extension of said piston into contact with the patient's chest are redirected to the thoracic cavity belt at opposite sides of the thoracic cavity.

2. The chest containment system of claim 1 wherein said flexible supplemental strap is releasably secured to said thoracic cavity belt.

3. The chest containment system of claim 1 wherein said flexible supplemental strap is releasably secured to said thoracic cavity belt by hook and loop securement.

4. In a chest containment system for the administration of cardiopulmonary resuscitation, the system having a powered compression device positionable on a patient's chest and having an extendable piston extending therefrom into contact with the patient's chest when the device is activated, said powered compression device having a top opposite the extendable piston; and
including a thoracic cavity belt attachable to said powered compression device and when in place on a patient circumscribing the patient's thoracic cavity to maintain a selected position of the powered compression device on the patient's chest; the improvement comprising:
(a) a flexible supplemental strap in contact with the top of said powered compression device, said strap extending from said top into contact with, and secured to, said thoracic cavity belt at opposite sides of the thoracic cavity, respectively;
whereby reaction forces resulting from the extension of said piston into contact with the patient's chest are redirected to the thoracic cavity belt at opposite sides of the thoracic cavity.

5. The chest containment system of claim 4 wherein said flexible supplemental strap is releasably secured to said thoracic cavity belt.

6. The chest containment system of claim 4 wherein said flexible supplemental strap is releasably secured to said thoracic cavity belt by hook and loop securement.

7. A method to facilitate the administration of cardiopulmonary resuscitation comprising:
(a) placing a powered compression device in contact with a patient's chest in a selected location;
(b) placing a thoracic belt around the patient's chest and securing ends of said thoracic belt to said powered compression device;
(c) tightening said thoracic belt to secure the belt and powered compression device in place in contact with the patient's chest;
(d) placing a supplemental strap in contact with the top of said compression device and releasably securing opposite ends of said supplemental strap to said thoracic belt at the sides of the patient's thoracic cavity.
